(19) United States
(12) Patent Application Publication
(10) Pub. No.: US 2018/0014368 A1
(43) Pub. Date: Jan. 11, 2018

(54) OPERATION OF LED LIGHTING ELEMENTS UNDER CONTROL WITH A LIGHT SENSITIVE ELEMENT

(71) Applicant: PHILIPS LIGHTING HOLDING B.V., EINDHOVEN (NL)

(72) Inventors: HARALD JOSEF GUNTHER RADERMACHER, EINDHOVEN (NL); THEODORUS JOHANNES PETRUS VAN DEN BIGGELAAR, EINDHOVEN (NL); BOB BERNARDUS ANTHONIUS THEUNISSEN, EINDHOVEN (NL); PETER VAN DELFT, EINDHOVEN (NL)

(21) Appl. No.: 15/542,928

(22) PCT Filed: Jan. 6, 2016
(86) PCT No.: PCT/EP2016/050123

§ 371 Date: Jul. 11, 2017

(30) Foreign Application Priority Data
Jan. 13, 2015 (EP) 15150868.6

(51) Int. Cl. H05B 33/08

(52) U.S. Cl. CPC H05B 33/083; H05B 33/0827; H05B 33/0851

(57) ABSTRACT

A circuit and a method of operating LED lighting elements are described. The circuit comprises a first and a second LED lighting element (20, 30). In order to provide a circuit and operating method with reduced complexity, a control circuit (50) controls operation of the first LED lighting element in dependence on a light feedback signal L from a light sensitive element (52). The signal L is dependent on light emitted from the second LED lighting element (30). Said first and said second LED lighting element (20, 30) are in series connection and said control circuit (50) is in parallel connection with said first LED lighting element (20); or said first and said second LED lighting element (20, 30) are in parallel connection and said control circuit (50) is in series connection with said first LED lighting element (20).

### FIELD OF THE INVENTION

The Invention relates to an electrical circuit including LED lighting elements and to a method of operating LED lighting elements.

### BACKGROUND ART

One option for operation of LED lighting elements is to transform available electrical power to voltage and current values as required by the LED lighting elements. For example, a driver circuit may transform an available AC mains power by rectifying, stabilizing and converting to a suitable voltage/current level, e.g. by a step down SMPS.

As an alternative approach, tapped linear driving (TLD) has been proposed, where the load is adapted to the currently available electrical supply instead of transforming a time-variant input power to achieve steady values. This is achieved by connecting only fractions of the total available number of LED lighting elements to input power.

In order to achieve an adaptive load, a driver circuit may comprise measuring means to determine available current or voltage levels, switching means for connecting appropriate portions of the LED elements and control circuitry to activate the switching elements suitably depending on the detected values. Thus, the driver circuit may require a relatively large number of components.

CN 103 260 296 describes a multi-branch linear driver connected to a plurality of series-connected LEDs connected in branches. A feedback control module is provided to control a branch current. The feedback control module effects low-pass filtering. The feedback control module may comprise a weighted summation module for the current of each branch to obtain a weighted sum of current demand.

US20140292218A1 discloses a transistor LED ladder driver. In FIG. 5 it discloses a topology in which the light emitted by the LED is used for controlling the ladder driver. More specifically, LED D1 and LED D2 are in series, and there is a MOSFET G1/Q1 in parallel with the LED D2. LED D2's light emission is detected by a phototransistor T1 to establish cut-off of G1 and Q1. This process replicates itself for higher sections.

### DISCLOSURE OF INVENTION

It may be considered an object to provide a circuit and operating method with reduced complexity.

This object is solved by a circuit according to claim 1 and by an operating method according to claim 15. Dependent claims refer to preferred embodiments of the invention.

The inventors have determined a number of potential problems associated with prior known circuits used for driving and/or controlling LED lighting elements. It should be noted that the term ‘LED lighting element’ here is used in a broad sense to encompass all different sorts of solid state lighting elements, including light emitting diodes of any type, laser diodes, OLEDs, etc., as well as combinations thereof, in particular clusters of individual LED elements connected in series, in parallel or in series-parallel configurations.

Problems of prior art control circuitry and methods, in particular of TLD drivers, may include one or more of a high part count, complex structure, reduced energy efficiency due to driver losses, and variations due to tolerances, aging and temperature dependency of component properties. The inventors have aimed to propose improved control circuitry solving at least one and preferably more than one of the above problems, in particular for LED lighting elements in TLD configurations, i.e. connected to be selectively activated depending on a control signal.

A circuit according to the invention in its most simple form comprises at least a first and a second LED lighting element. For ease of reference, the first LED lighting element may also be referred to as a controlled LED lighting element, and the second LED lighting element may be referred to as monitored LED lighting element. As will be described below and become apparent in connection with preferred embodiments, further LED lighting elements may be present. Such further LED lighting elements may e.g. be provided in series, in parallel, or as any combination of series/parallel connections. For example, at least one further LED lighting element may be provided electrically in series with the first and/or with the second LED lighting element.

A light sensitive element is arranged to deliver a light feedback signal dependent on at least a portion of the light emitted from the second (monitored) LED lighting element. The light sensitive element may be any electrical component or circuit, or combination of electrical components or circuits responsive to light, such as light dependent resistors, phototransistors, photodiodes, LEDs, etc. The portion of light from the second LED lighting element which leads to the light feedback signal may be of any optical wavelength or range of wavelengths, including light in the visible range and beyond, such as infrared or ultraviolet. The light feedback signal may be derived from the total luminous flux emitted from the second (monitored) LED lighting element or from a portion thereof. The light feedback signal may be an instantaneous value of currently emitted light, or may be processed, such as by averaging over time. In a case where the second LED lighting element is comprised of a plurality of components, such as e.g. multiple LEDs connected in parallel or in series, the light feedback signal may be derived from one or more, but not necessarily from all LEDs.

The light sensitive element may be provided separately or as part of a control circuit, which is provided for controlling operation of the first LED lighting element. This may include turning the first (controlled) LED lighting element on or off, or controlling operation thereof in multiple stages, or according to variable parameters. In particular, the first (controlled) LED lighting element may be controlled by providing different values of electrical operating current thereto.

According to the invention, control of the first LED lighting element is effected in dependence on the light feedback signal. Thus, a control path according to the invention includes an optical portion.

According to the invention, it is thus possible to operate two LED lighting elements in dependence, based on a light feedback signal. This may provide advantages in particular for obtaining desired lighting results, such as e.g. to minimize variations in optical flux. Relevant control parameters may be more directly obtained in this way than through electrical measurements of e.g. current or voltage. Tolerances of components, both of a driver circuit and of the LED lighting elements themselves, may be more easily compensated, along with external influences such as aging and temperature impact. Further, based on the invention, flexible control circuits may be proposed, which are easily adaptable for different types and different numbers of LED lighting elements. The basic configuration of two LED lighting elements may be cascaded to multiple LED lighting elements.

Different embodiments of the control circuit may provide different types of control behaviour, i.e. of dependence of the operation of the controlled first LED lighting element on the light feedback signal. The control behaviour, defined by the choice of electrical components of the control circuit, may for example include a defined threshold, such that the first LED lighting element is either turned on or off if the light feedback signal reaches the threshold.

The method of the invention proposes to obtain a light feedback signal dependent on at least a portion of light emitted from the second (monitored) LED lighting element, and to control operation of the first (controlled) lighting element in dependence on the light feedback signal.

The circuit and method according to the invention may be embodied in many different ways and have a large number of possible applications. Using a light feedback signal is especially advantageous if the first or the second LED lighting element, or both, are connected to an electrical power supply delivering varying values of voltage or current. By control through a light feedback signal, the circuit may adapt to the variations. This applies e.g. to potentially unreliable sources with unknown variations, but in particular to sources with periodically varying values, or to signals varying within a predefined range, e.g. a DC voltage with voltage values varying within a given tolerance band.

According to a preferred embodiment of the invention, at least one of the LED lighting elements, and preferrably both, are connected to an electrical power supply with periodically varying voltage. The connection need not be direct, i.e. there generally may be electrical components and circuits interposed, through which power from the power supply is delivered to the LED lighting element(s).

In one preferred configuration, examples of which will be discussed in greater detail below, the first and second LED lighting elements are electrically connected in series. Again, the connection need not be direct, but could as well be indirect with further elements, components and circuits in between. Preferrably, the series connection may be tapped, i.e. the control circuit may be connected to the interconnection point between the first and second LED element. The series connection may be powered by an electrical power supply with varying voltage, the control circuit may serve to apply an adapted load to the power supply.

The control circuit may be electrically connected in parallel to the first LED lighting element. Thus, control of the first (controlled) LED lighting element could be effected by variably bypassing a current, i.e. the first LED lighting element could be turned off by a low impedance of the control circuit, and be gradually turned on with increasing impedance, up to full operation if the control circuit has high impedance or no longer conducts current at all.

The dependence of operation of the first (controlled) LED lighting element on the light feedback signal from the second (monitored) LED lighting element may generally be chosen according to the requirements and specifications of the circuit, lighting elements and power supply. Control may be effected e.g. in two steps (on/off), or in a plurality of steps with increasing operating power, or gradually according to a steady function at least within one interval of values.

In one preferred embodiment, the control circuit is disposed to provide for an increasing power delivered to the first LED lighting element with an increasing light feedback signal. Thus, the more light is emitted from the second (monitored) LED lighting element and contributes to the light feedback signal, the more power may be provided for operation of the first (controlled) LED lighting element. The control circuit may allow for increased electrical power to be delivered to the first LED lighting element, e.g. by means of controllable switches which connect the first LED lighting element to a source of current and/or voltage, or which close a bypass of electrical power,

As shown in specific embodiments below, increasing operation of the first (controlled) LED lighting element with increasing light detected from the second (monitored) LED lighting element has particular applications in a series connection of the two LED lighting elements, connected to a varying power supply, in particular to a periodically varying power supply. In particular, this configuration may be used to implement at least two-stage TLD control without the necessity of measuring the momentarily available voltage. This is not limited to only two stages, but further LED lighting elements, further control circuits, and/or further light sensitive elements may be provided to effect multi-stage control.

According to one preferred embodiment, the circuit includes at least one further LED lighting element and control circuit for controlling operation of the further LED lighting element. A further light sensitive element may be arranged to obtain a further light feedback signal derived from the light emitted from the first LED lighting element, and the further control circuit may control operation of the further LED lighting element depending on the further light feedback signal. Thus, it is possible to arrange one or more further LED lighting elements in a cascaded structure together with the first and second LED lighting elements.

The control circuit may comprise a bypass current path, allowing a bypass current to flow, and an optical feedback circuit to at least reduce the bypass current, or even turn off the bypass current entirely, with an increasing light feedback signal. The bypass current may in particular be a start-up current that allows operation of at least a part of a series connection of at least the first and second LED lighting elements to operate if a relatively low voltage is delivered.

Alternatively to the above described configuration of the first and second LED lighting element connected in series, the LED lighting elements may also be electrically connected in parallel. Again, connection of both LED lighting elements to a common electrical power supply is preferred, and control may be particularly advantageous in the case of a periodically varying voltage supplied. The connection of the first and second LED lighting elements in parallel may include further circuit elements in series or in parallel, electrical fuses, thermal fuses, or any loads such as resistors, Zener diodes, etc. with one or both of the LED lighting elements, e.g. further LED lighting elements.

The control circuit may be electrically connected in series to the first (controlled) LED lighting element. This is in particular preferred in a circuit with first and second LED lighting elements connected in parallel.

The control circuit may be disposed to decrease power delivered to the first (controlled) LED lighting element with an increasing light feedback signal. The control circuit may allow for decreased electrical power to be delivered to the first LED lighting element, e.g. by means of controllable switches which e.g. cut off the first LED lighting element from supplied electrical power, or which connect the first LED lighting element to a source of lower current and/or voltage, or which open a bypass of electrical power, This may in particular be preferred in a configuration with the first and second LED lighting element electrically connected in parallel. In this way, the load may be adapted to a varying electrical power supply.

Generally, it is preferred to provide a current limiting means connected to limit a current supplied by an electrical power supply either directly or indirectly to the first and/or second LED lighting element. The current limiting means may be, in the simplest case, a resistor, but could also realized as a fixed value current source or even a modulated current source.

In one embodiment, the optical spectrum used for monitoring may be different from the optical spectrum used for illumination purposes. This may be achieved e.g. by an LED lighting element with broadband emission, but a light sensitive element of only narrowband sensitivity. Alternatively, it is possible to provide at least the second LED lighting element with at least two separate LEDs, e.g. in parallel or in series configurations. A first of the two LEDs may have a desired emission spectrum for illumination purposes, in particular white light. The second LED may have a second, generally narrower emission spectrum for efficient excitation of the light sensitive element. For example, the second LED may be a blue LED. It is possible to shield the light output from this second LED such that the light is only delivered to the light sensitive element, e.g. by providing an optical shield.

The elements of the circuit according to the invention may be separate, discrete electrical components. However, a combination of two or more of the elements in one component may be possible. For example, the first and second LED lighting element (as well as optionally further LED lighting elements) may be combined in one component, or one or both LED lighting elements may be combined with the light sensitive element (as well as optionally further components of the control circuit). The combination may in particular comprise two or more of the elements provided on a common substrate.

Another aspect of the invention provides a structure for providing optical coupling, for example between the lighting device and the light sensors of the light unit according to the first aspect. This aspect uses a cavity in a PCB as light propagation path.

One embodiment of the above aspect provides:
an electronic device comprising:
a light emitter;
a light receiver adapted to receive light emitted by said light emitter; and
a substrate on which said light emitter and said light receiver are mounted;

wherein said substrate comprises a hole and said light emitter is adapted to emit light into the hole and said light receiver is adapted to receive light from the hole.

In this embodiment, the hole can concentrate the light propagation between the light emitter and the light receiver, thus improves the optical coupling there between.

In a further embodiment, the hole is a through hole, and the light receiver and the light emitter are mounted on opposite side of the substrate and on a respective opening of the hole. In this embodiment, the light emitted by the light emitter passes through the hole to reach the light receiver.

In an alternative embodiment, the hole is a blind hole with one opening on one end and reflective material on the other end, the light receiver and the light emitter are mounted on the same side of the substrate and facing the opening of the hole. In this embodiment, the light emitted by the light emitter is reflected back to the light receiver by the reflective material. Since the light emitter and light receiver are on the same side, the thickness can be reduced.

In a further embodiment, at least one of the light emitter and the light receiver is placed within the hole. This embodiment can further reduce the distance between the light emitter and receiver thus improves optical coupling. To realize this embodiment, the electronic device further comprises a gull wing bracket, wherein a wing portion of the bracket is attached to the rim of the hole and a body portion is extending into the hole and carrying the light emitter or the light receiver.

In a further embodiment, the inner wall of the hole comprises reflective material, such as the hole comprises a through Via, adapted to redirect the light emitted from the light emitter to the light receiver. In this embodiment, the emitted light that is not shining perpendicular into the hole is reflected by the side walls of the Via and optical coupling is improved.

These and other aspects of the invention will be apparent from and elucidated with reference to the embodiments described hereinafter.

### BRIEF DESCRIPTION OF THE DRAWINGS

FIG. 1 shows a partly symbolical circuit diagram of a first embodiment of a circuit with a series connection of LEDs;

FIG. 2 shows a partly symbolical circuit diagram of a second embodiment of circuit with a parallel connection of LEDs;

FIG. 3 shows a partly symbolical circuit diagram of a third embodiment of a circuit with a plurality of LEDs in series connection;

FIG. 4 shows a circuit diagram of a fourth circuit;

FIG. 5 shows a diagram of currents and voltages in the circuit of FIG. 4;

FIG. 6 shows a fifth embodiment with multiple LED stages;

FIG. 7 shows a circuit diagram of a sixth embodiment of a circuit;

FIG. 8 shows a circuit diagram with a seventh embodiment of a circuit;

FIG. 9 shows a schematical sectional view of elements of the circuit of FIG. 8;

FIG. 10 shows a partly symbolical circuit diagram of an eighth embodiment of a circuit;

FIG. 11 shows a diagram of currents and voltages in the circuit of FIG. 10;

FIGS. 12 to 15 show different embodiments of an optical coupling structure according to a second aspect of the invention.

### DESCRIPTION OF EMBODIMENTS

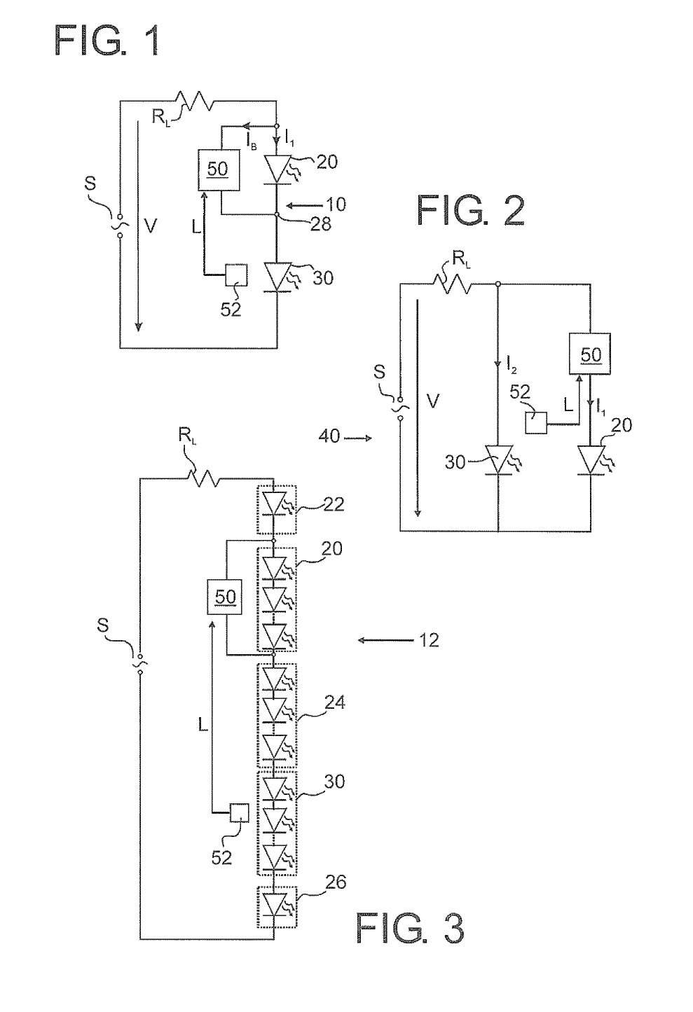

FIG. 1 shows a first exemplary embodiment of a circuit 10 comprising an electrical power supply S and a current limiting resistor R_{L}. A first LED lighting element 20 and a second LED lighting element 30 are electrically connected in series to the current limiting resistor R_{L} and electrical power supply S. A control circuit 50 is electrically connected in parallel to the first LED lighting element 20. The control circuit 50 comprises an optical sensor 52 arranged in proximity of the second LED lighting element 30.

The control circuit 50 is connected to an interconnection point 28 between the LED lighting elements 20, 30. Thus, the LED lighting elements 20, 30 are configured as a tapped configuration with two segments which may be controlled differently.

The first embodiment of a circuit 10 as shown in FIG. 1 is a very simple example of two LED lighting elements 20, 30 in series configuration. In this example, the LED lighting elements are single LED elements 20, 30. It should be noted that instead of the shown single LED elements 20, 30, also groups of e.g. series connected individual LED elements could be used.

The control circuit 50 is arranged to control operation of the first LED lighting element 20, which may thus be referred to as a controlled LED lighting element 20. The control circuit 50 may allow a bypass current I_{B} to flow, thus diminishing an operating current I₁ of the first, controlled LED lighting element 20.

The light sensitive element 52, which may be part of the control circuit 50, generates a light feedback signal L depending on the light output of the second LED lighting element 30. Operation of the second LED lighting element 30 is thus monitored, such that it may be referred to as a monitored LED lighting element 30.

In the example of FIG. 1, the electrical power supply S provides a sinusoidally varying, rectified supply voltage V, which is applied over the current limiting resistor R_{L} to the series connection of the controlled LED lighting element 20 and monitored LED lighting element 30. The supply voltage V thus varies periodically. If the supply voltage V is not sufficient to operate both LED lighting elements 20, 30, i.e. if the voltage is below the sum of their forward voltages (and the voltage drop at the current limiting resistor R_{L}), the control circuit 50 is used to deactivate the first, controlled LED lighting element 20 by bypassing it, allowing the bypass current I_{B} to flow.

This allows operation of the second, monitored LED lighting element 30.

As the voltage increases and the second, monitored LED lighting element 30 is operated with increasing current, an increased luminous flux is obtained therefrom. A portion of the light emitted from the second LED 30 lighting element leads to an increasing light feedback signal L. In response to the increasing light control signal L, the control circuit 50 closes the bypass current path, thus reducing the bypass current I_{B} and consequently allowing the first, controlled LED lighting element 20 to be operated with increasing operating current I₁.

When, at the end of the cycle, the supply voltage V again drops, the operating current of the second, monitored LED 30 diminishes and consequently the emitted light and derived light feedback signal L are reduced. The control circuit 50 in response again opens the bypass current path, increasing the bypass current I_{B}, thus decreasing I₁ and eventually turning off the first, controlled LED 20.

Thus, as demonstrated by the very simple example of the circuit 10 according to the first embodiment, an adaptive load may be provided by selectively activating the available LED lighting elements in segments, i.e. in the present example operating either only one or both of the available LED lighting elements 20, 30 in response to the available operating voltage V. Control is achieved without directly measuring the voltage V or the resulting current. Instead, control relies on the light feedback signal L, automatically achieving the desired adaptive load.

FIG. 2 shows a circuit 40 according to a second basic embodiment. In the second embodiment, as well as in all further embodiments, parts and components also comprised in other embodiments will be designated by the same reference numerals.

In the circuit 40, a first (controlled) LED lighting element 20 and a second (monitored) LED lighting element 30 are connected to an electrical power supply S via a current limiting resistor R_{L}. Contrary to the first embodiment, the first and second LED lighting elements 20, 30 are electrically connected in parallel, and the control circuit 50 for controlling operation of the first LED lighting element 20 is connected thereto in series.

As in the first embodiment, a light feedback signal L is obtained by a light sensitive element 52 and the control circuit 50 effects control in dependence on the light feedback signal L.

The supply voltage V delivered by the power supply S as a sinusoidal, rectified voltage is applied to the parallel connection of the LED lighting elements 20, 30. At low available voltages, the control circuit 50 is conducting, i.e. allows an operating current I₁ to flow through the first, controlled LED lighting element 20.

As an increased current I₂ flows through the second LED lighting element 30 and the luminous flux increases, an increasing light feedback signal L is obtained. In response to the increasing light feedback signal L, the control circuit 50 reduces the operating current I₁ of the first, controlled LED lighting element 20.

For example, the second, monitored LED lighting element 30 may have a larger forward voltage than the first LED lighting element 20. For example, the first LED lighting element 30 may be a string of individual LEDs, and the first LED lighting element 20 may be a single LED, or a string with fewer LEDs.

At low voltages V below the forward voltage of the second, monitored LED lighting element 30, no current I₂ will flow, so that only the first, controlled LED lighting element 20 will operate. As the voltage V increases above the forward voltage of the second, monitored LED lighting element 30 and effects operation thereof, the control circuit 50 shuts down operation of the first LED 20 in response to the increasing light feedback signal L. During the portion of the period with high enough voltage V, only the second, monitored LED 30 is then operated, until the voltage again falls below the forward voltage thereof.

Thus, also for the second, alternative embodiment a variable load is achieved in response to a varying voltage V. Control is effected automatically through the light feedback signal L without the necessity of measuring the supply voltage V.

FIG. 3 shows the third embodiment of a circuit 12. The circuit 12 according to a third embodiment comprises a series configuration as in the first embodiment of FIG. 1. In the following, only differences will be explained.

In the third embodiment, both the first, controlled LED lighting element 20 and second, monitored LED lighting element 30 are comprised of strings of individual LED elements connected in series.

Further LEDs are provided, in the example shown in series connection with the first and second LED lighting elements 20, 30. One LED 22 is connected between the current limiting resistor R_{L} and the first LED lighting element 20. A string of LED elements 24 is connected in series between the first and second LED lighting elements 20, 30. An LED 26 is connected between the second, monitored LED 30 and the power supply S.

As demonstrated by this embodiment, the total LED load available may comprise further LEDs, such as the LEDs 22, 24, 26 shown in FIG. 3. In the example shown, only light from the monitored second LED 30 will contribute to the light feedback signal L. Thus, the further LEDs 22, 24, 26 in the example are neither monitored nor directly controlled by the control circuit 50.

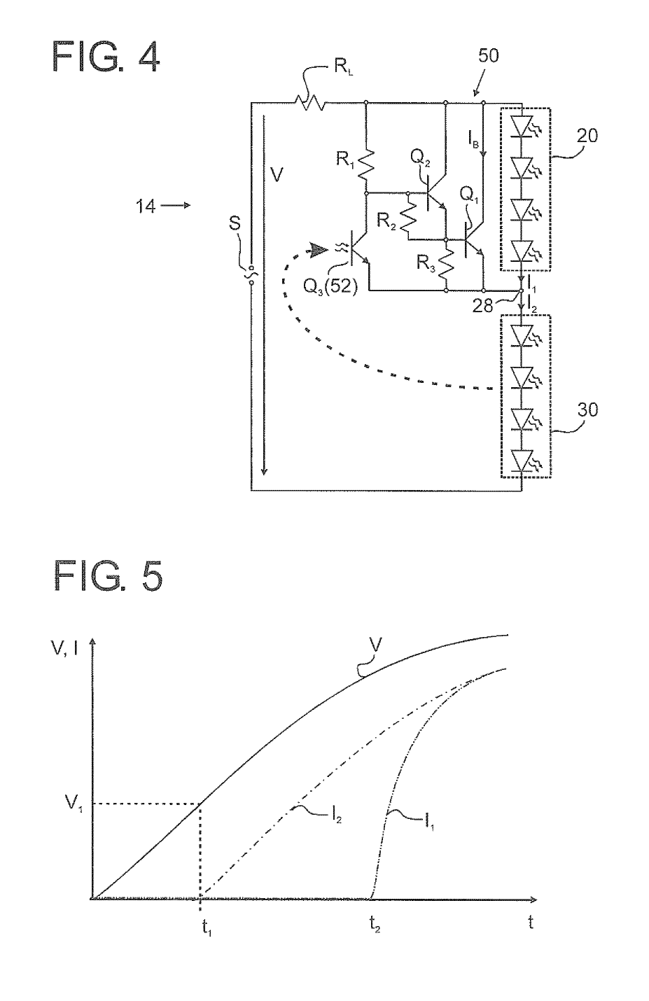

FIG. 4 shows a third embodiment of a circuit 14 with an LED load with the first and second LED lighting element 20, 30 connected to a power supply S delivering a sinusoidally varying, rectified voltage V through a current limiting resistor R_{L}. The first and second LED lighting element 20, 30 are each a string of series connected individual LED elements.

A control circuit 50 is connected in parallel to the first LED lighting element 20 and comprises a phototransistor Q₃ as light sensitive component 52, which is illuminated by a portion of the light emitted from the second LED lighting element 30.

In the circuit 14 according to the fourth embodiment, the control circuit 15 is realized with bipolar transistors Q₁, Q₂. Also, the phototransistor Q₃ is a bipolar transistor.

The control circuit 50 comprises a current path for a bypass current I_{B} through the transistor Q₁ if activated. The current through the first LED 20 is I₁, the current through the second LED 30 is I₂.

Transistors Q₁, Q₂ are interconnected in a Darlington circuit with resistors R₂, R₃. The base of transistor Q₂ is connected to the current limiting resistor R_{L} through a resistor R₁. The resistance value of resistor R₁ is relatively high, e.g. 10 kΩ. The collectors of both transistors Q₁, Q₂ are directly connected to the current limiting resistors R_{L}. The emitter of the second Darlington transistor Q₁ is connected to an interconnection point 28 between the first and the second LED 20, 30.

The photo transistor Q₃ is connected between the base of Q₂ and the interconnection point 28, and thus in series with the first resistor R₁, the series connection being arranged in parallel to the Darlington circuit.

A resistance value of resistor R₁ results in a certain “pull-up” current, while the phototransistor Q₃ draws a certain “pull-down” current. In combination with the resistors R₂ and R₃, this defines the control behavior.

FIG. 5 shows the supply voltage V and the currents I₁, I₂ for the first half of a cycle of the rectified sinusoidal voltage V supplied by the electrical power supply S.

For low-voltage values below the forward voltage of both LED lighting elements 20, 30, no current flows, such that no light is emitted by either of the LED lighting elements 20, 30. The second LED lighting element 30 is not operating, thus there is no light on the phototransistor Q₃. Consequently, Q₃ is deactivated, exhibiting a high-resistance between collector and emitter.

Q₁ is activated, via Q₂ and R₁, so that the bypass current path for the bypass current I_{B} is enabled. The first LED 20 is therefore bypassed and thus deactivated.

As the voltage V increases to a voltage value V₁ at time t₁ as shown in FIG. 5 (here neglecting voltage drop over R_{L} and Q₁), where V₁ is equal to the forward voltage of the second LED lighting element 30, a current I₂ starts to flow and increase as shown. The control behaviour, defined by the component values and characteristics of the components of the central circuit 50, in particular R₁, R₂, R₃, Q₁, Q₂, Q₃, is chosen such that I₂ starts to flow after V₁ has reached a high enough value, above the required forward voltage.

Consequently, the second LED lighting element 30 emits light. The luminous flux will increase with increasing I₂.

A portion of the total luminous flux will reach the photo transistor Q₃, creating a photo current in the base and enabling a collector/emitter current. This current will reduce the driving signal for Q₂ and Q₁, ultimately turning off Q₁ completely.

Thus, the more light is emitted from the second LED lighting element 30, the more the current path for the bypass current I_{B} is closed. This, in turn, means that the first LED lighting element 20 is no longer bypassed, but now activated. Because of the high resistance value of resistor R₁, the current flow through Q₃ is negligible.

Consequently, from time t₂ on, the current, and thus power, delivered by the source S will flow through the complete string of LEDs 20, 30.

This requires that the supply voltage delivered at time t₂ has to be at least equal to the sum of forward voltages of both LED lighting elements 20, 30. This dependency is to be reflected in the V/I characteristics of the control circuit for driving Q₁. Hence, in this case, the control signal is partly based on the optical measurements, namely the light feedback signal delivered as collector-emitter resistance of Q₃, and also on an electrical parameter, namely the required forward voltage of the first LED lighting element 20.

In a preferred design, a voltage equal to the forward voltage of the second LED lighting element 30 has to be present across Q₁ in order to allow for a current through the first LED lighting element 20 high enough to generate the photo current for turning off Q₁.

Thus, the circuit 14 shown in FIG. 4 effectively realizes TLD control of two different LED lighting elements 20, 30, which are selectively activated depending on the available voltage V without actually measuring this voltage.

The proposed circuit further has the advantage, that the feedback signal is based on the actual luminous flux emitted by the monitored LED lighting element 30, such that changes in the emission efficiency are taken into account automatically.

While the circuit 14 as shown in FIG. 4 provides optical feedback based on the instantaneous flux of the second, monitored LED lighting element 30, alternative embodiments may effect control based e.g. on a timely averaged flux. For example, a capacitor (not shown) could be installed in parallel to the collector/emitter of Q₃ such that the drive signal for Q₁ will depend on the average of the light generated by the second, monitored LED lighting element 30. As a still further alternative, more sophisticated filters, such as e.g. RC networks may be used to implement delays etc.

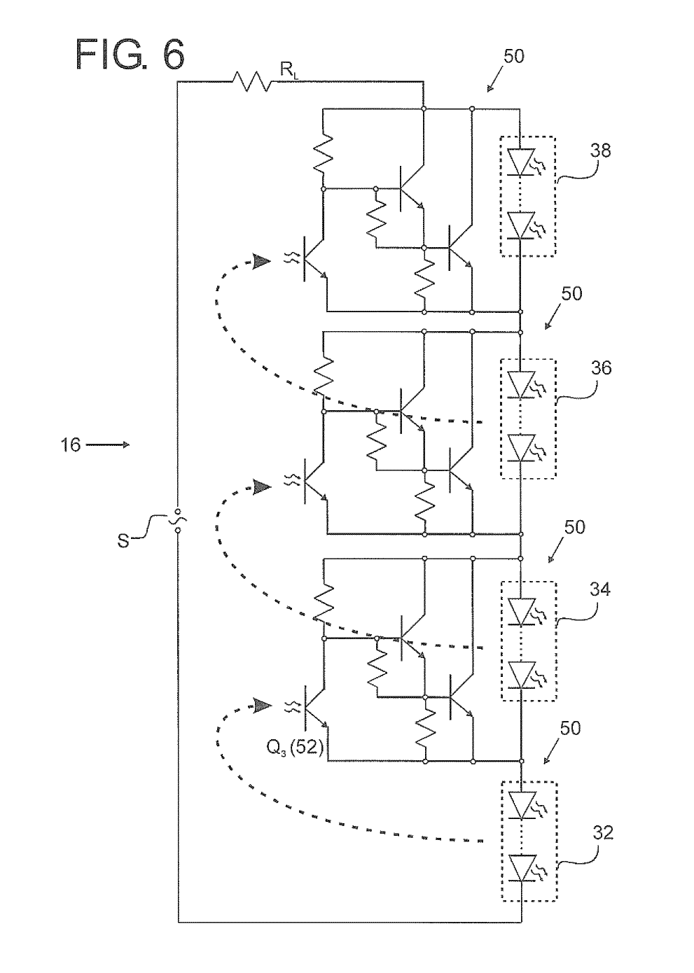

FIG. 6 shows a circuit 16 according to a fifth embodiment. Corresponding to the first, third and fourth embodiments, the circuit 16 according to the fifth embodiment is based on a series arrangement of LEDs. As visible, the circuit 16 shown in FIG. 6 comprises multiple control circuits of the same structure as the control circuit 50 shown in FIG. 4 as part of the circuit 14. In fact, while the circuit 14 of FIG. 4 implements, as described above, a TLD driver with optical feedback for two separate LEDs (or LED segments), the circuit 16 shown in FIG. 6 applies the same concept to a TLD driver with four LEDs (or LED segments).

The circuit 16 comprises a source S delivering a (rectified) sinusoidal voltage over a current limiting resistor R_{L} to series connected LED lighting elements 32, 34, 36, 38. Each LED lighting element 32-38 is realized as a string of individual LEDs.

Each LED lighting element 32-38, except for the LED lighting element 32 has a control circuit 50 connected in parallel thereto. The LED lighting element 32 is a monitored LED lighting element, with a portion of the emitted light illuminating the photo transistor Q₃ of the control circuit 50 of the adjacent LED lighting element 34.

The LED lighting elements 34-38 and their respective control circuits 50 are arranged cascaded. The LED lighting elements 34, 36 are both controlled and monitored LEDs, the LED lighting element 34 providing an optical feedback to the control circuit 50 of the adjacent LED 36 lighting element, and the LED 36 providing an optical feedback to the control circuit 50 of the adjacent LED 38. The LED lighting element 38 is a controlled LED lighting element.

As the skilled person will recognize from the above description of the function of each individual control circuit 50, the circuit 16 implements a TLD driver for the four LED lighting elements 32-38. As the voltage delivered from the source S increases from zero, the control circuits 50 provide bypass current paths, so that first the LED lighting element 32 is turned on. The light feedback signal provided to the control circuit 50 of the adjacent LED lighting element 34 then gradually leads to activation of the LED lighting element 34 in addition to the LED lighting element 32. With further increasing voltage and increasing luminous flux and therefore light feedback signal, the LED lighting elements 36 and 38 are turned on in succession in addition to the LED lighting elements 32 and 34.

As the voltage decreases again, the decreasing light feedback signals lead to subsequent deactivation of the LED lighting elements 38, 36 and 34.

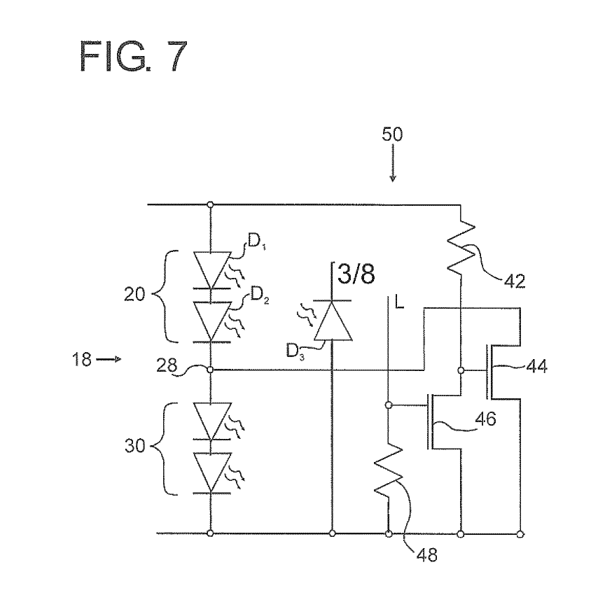

FIG. 7 shows a circuit 18 according to a sixth embodiment. A first and second LED lighting element 20, 30 are arranged in series. The electrical power supply S and current limiting resistor RL which supply the series connection with electrical power are not shown in FIG. 7.

The LED lighting elements 20, 30 in circuit 18 are each implemented as a series connection of two individual LEDs. In this example, the first LED lighting element 20 is comprised of two different LEDs D₁, D₂ of different color. While D₁ is a white LED emitting the usable light, i.e. of high luminous flux for illumination purposes, D₂ is a blue LED for efficient excitation of the photo diode D₃ acting as optical detector 52.

The control circuit 50 comprises a first FET 44 and second FET 46. The first FET 44 is connected with drain and source between an interconnection point 28 of the LEDs 20, 30 and ground. The gate of the first FET 44 is connected to the supply voltage over a first resistor 42.

The second FET 46 is connected with drain and source between the gate of the first FET 44 and ground. The gate of the second FET 46 is connected to ground via a second resistor 48 and to the photo diode D₃.

The first resistor 42 acts as pull-up resistor rendering the first FET 44 conductive if a sufficient positive voltage is applied. Pull-up resistor 42 defines the default-on behaviour of the first FET 44, such that the first LED lighting element 20 is initially turned on, and second LED lighting element 30 turned off because it is bypassed by FET 44.

The two FETs 44, 46 are effectively connected to form an inverter circuit. As the first LED lighting element 20 is operated and emits light with increasing luminous flux, the blue light emitted from D₂ leads to a photo current in photo diode D₃, creating a light feedback signal L. The light feedback signal activates the second FET 46, thus turning off the first FET 44 because of the inverter circuit.

Thus, the second LED lighting element 30 is now activated in addition to the first LED lighting element 20.

Alternatively, the inverting function of the inverter circuit formed by the two FETs 44, 46 and the resistors can be replaced with a single depletion mode FET, resulting in reduced component count. As a drawback, there is a limited choice for depletion mode FETs as compared to enhancement mode FETs.

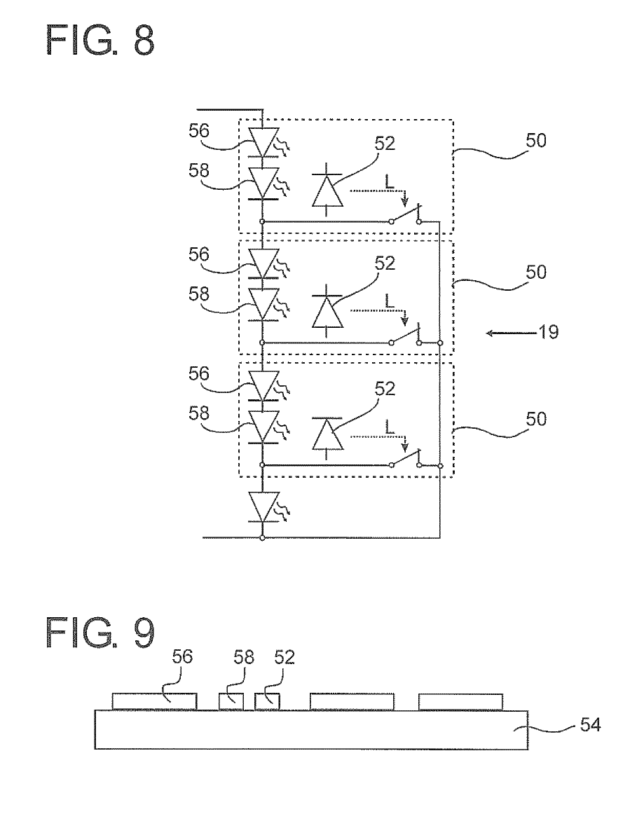

FIG. 8 shows a circuit 19 according to a seventh embodiment, illustrating how the basic idea realized in the sixth embodiment and explained above can be applied to multiple LED segments instead of only two LED lighting elements. Each driver circuit 50 comprises an LED 52 used as photo diode connected to a controllable switching element, which is initially closed conducting and may be opened if a signal L is applied.

If a variable voltage is applied between the supply terminals (the power supply may be the same as above and is not shown here) the LED lighting elements will light up from top to bottom in FIG. 8 as the voltage increases. Each photo diode delivers a light feedback signal L opening the associated controllable switch as soon as a high enough signal level is reached. The exact level, at which the controllable switches open, will be chosen in accordance with the required forward voltage for activating the LEDs 56, 58.

FIG. 9 shows in a schematical representation placement of components on a die 54. As schematically shown here, a white LED 56 used for illumination purposes may be placed next to a blue LED 58 used for monitoring. The LEDs 56, 58 may be connected in series. The monitored LED 58 is placed next to a photo diode 52, such that the light feedback signal L is obtained as the monitored LED 58 is active. Further LEDs may be placed on the same die.

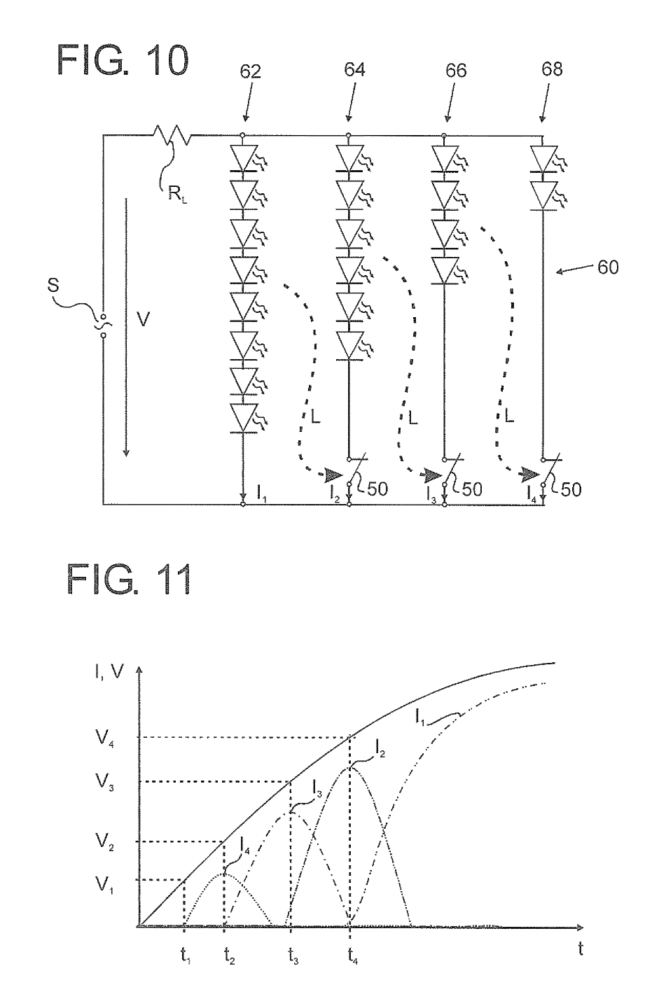

FIG. 10 shows an eighth embodiment of a circuit 60. The circuit 60 according to the eighth embodiment is an implementation of a parallel arrangement of LEDs, connected to a common electrical power supply S via a current limiting resistor R_{L}.

A plurality, in the example shown four LED strings 62, 64, 66, 68 are connected in parallel. The strings 62-68 have different numbers of individual LEDs. The first string 62 has the highest number of LEDs, and thus the highest forward voltage. The second, third and fourth strings 64-68 are electrically connected in series to control circuits 50, here shown only as controllable switches activated by a light signal.

The strings 62-68 are arranged in a cascade, with the first string 62 providing a light feedback signal L to the control circuit 50 of the second string 64, the second string 64 delivering a light feedback signal L to the control circuit 50 of the third string 66, and so on.

FIG. 11 shows a diagram of the voltage V and currents I₁-I₄ through the individual strings 62-68 over time t. The supplied voltage V is a rectified sinusoidal voltage.

Initially all control circuits 50 activate the corresponding strings 64-68, i.e. with no light control signal L the switches are closed.

In an initial period below the lowest forward voltage, no current will flow. At time t₁ the forward voltage V₁ of the fourth string 68 is reached, such that a current I₄ flows and increases.

At time t₂ the voltage V reaches a value V₂ equal to the forward voltage of the third string 66, such that a current I₃ starts to flow. The LEDs of string 66 are activated and emit light, leading to a light control signal L. With increasing light control signal L, the control circuit 50 of the fourth string 68 decreases the flow of current I₄ therethrough, such that the fourth string 68 eventually is turned off.

At time t₃, when the voltage V has reached a voltage value V₃ equal to the forward voltage of the second string 64, activation of this string 64 leads to deactivation of the third string 66 via the light control signal L. In the same way, starting from t₄, when the voltage V reaches a value V₄ equal to the forward voltage of the first string 62, the second string 64 is deactivated.

Thus, the circuit 60 of FIG. 10 achieves a variable load of selectively activated LEDs dependent on the supply voltage V without measurement thereof.

It should be noted that the above-mentioned embodiments illustrate rather than limit the invention, and that those skilled in the art will be able to design many alternative embodiments without departing from the scope of the appended claims. For example, the above described circuits may be adapted through either two separate LEDs or LED segments, or cascaded to a larger number of LEDs or LED segments, thus e.g. realizing TLD configurations with different numbers of separately operable stages.

Besides the above explained application to serial configurations and parallel configurations, the concept may be applied to mixed series/parallel arrangements (matrix) of LEDs, as known from electrically controlled matrix linear driving. Flicker reduction methods may be applied with storage capacitors.

While the invention allows operation without direct measurement of a supply voltage, control effected may be based, besides the optical feedback signal, also on electrical measurements of voltage, current or power, and/or on ambient measurements, e.g. of temperature, ambient light level etc. Thus, different control strategies and control inputs may be combined with the underlying optical control scheme without losing the benefits of the proposed concept.

The granularity, i.e. the number of separately operable LED segments, and the sensitivity to the light feedback signal may be chosen to cover various applications, in particular compatibility with different input voltage ranges. As an example, four building blocks with a forward voltage of 70 V each can be powered from a rectified 230 V mains grid, while four building blocks with 35 V each can be powered from a rectified 115 V mains grid.

Another aspect of the invention provides a structure for providing optical coupling, for example between the second LED lighting element and the light sensitive element. This aspect uses a cavity in a PCB as light propagation path.

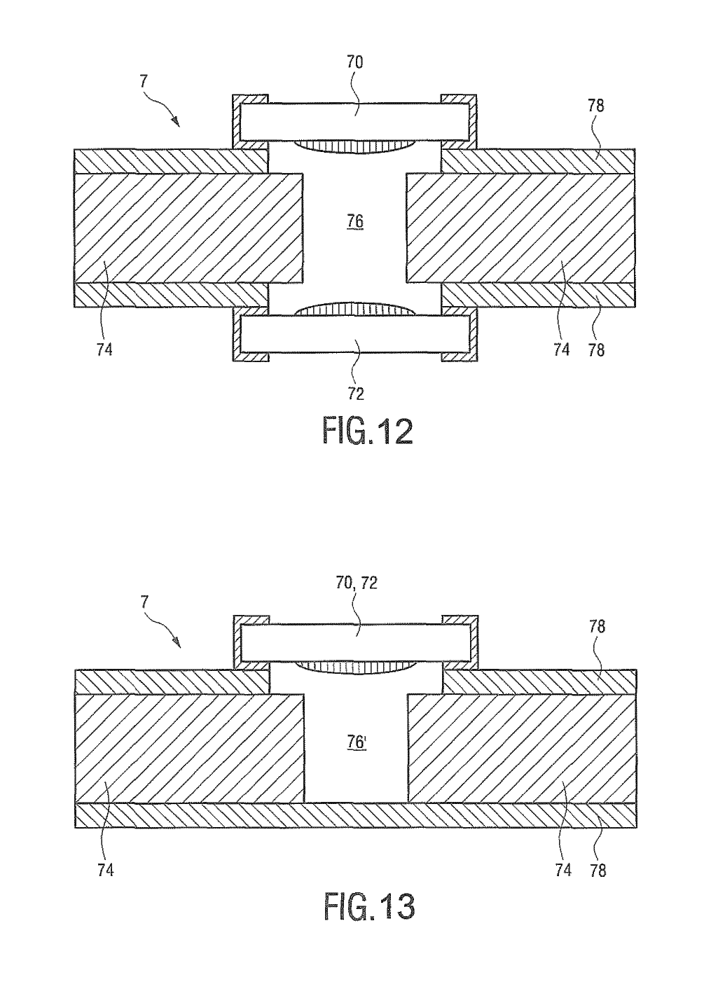

FIG. 12 shows the cross section/side view of an embodiment according to the above aspect. An electronic device 7 comprises a light emitter 70; a light receiver 72 adapted to receive light emitted by said light emitter 70; and a substrate 74 on which said light emitter 70 and said light receiver 72 are mounted; wherein said substrate 74 comprises a hole 76 and said light emitter 70 is adapted to emit light into the hole 76 and said light receiver 74 is adapted to receive light from the hole 76.

In the shown embodiment, the hole 76 is a through hole, and the light receiver 72 and the light emitter 70 are mounted on opposite side of the substrate 74 and on a respective opening of the hole 76. More specifically, the substrate 74 is a PCB. Reference sign 78 denotes copper layer/trace on the PCB. More specifically, the proposed optical coupling is created using a drilled hole in the PCB with e.g. on the top-side the high voltage components, including the LED-load Surface Mounted Devices (SMD), including the light emitter LED. On the bottom side are the low voltage components including the detector LED as the light receiver,

In an alternative embodiment as shown in FIG. 13, the hole 76′ is a blind hole with one opening on one end and reflective material on the other end. In this embodiment the other end of the hole 76′ is the copper layer 78. The light receiver 72 and the light emitter 70 are mounted on the same upper side of the substrate 74 and facing the opening of the hole 76′.

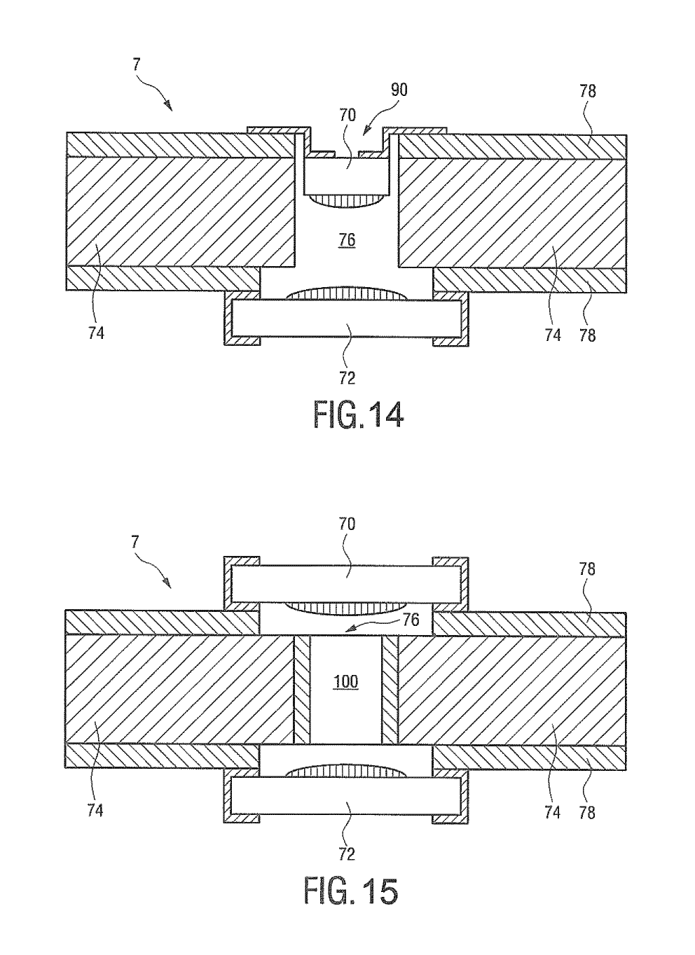

In a further embodiment, at least one of the light emitter and the light receiver are placed within the hole. As shown in FIG. 14, the light emitter is mounted within the hole. This embodiment can further reduce the distance between the light emitter and receiver thus improves optical coupling. To realize this embodiment, the electronic device further comprises a gull wing bracket 90, wherein a wing portion of the bracket is attached to the rim of the hole 76 and a body portion is extending into the hole and carrying the light emitter 70. It should be understood that, alternatively or additionally, the light receiver could also be mounted on a similar gull wing bracket and placed within the hole.

In a further embodiment as shown in FIG. 15, the inner wall of the hole comprises reflective material such as a through Via 100 adapted to redirect the light emitted from the light emitter 70 to the light receiver 72. In this embodiment, the emitted light that is not shining perpendicular into the hole is reflected by the side walls of the Via and optical coupling is improved. It should be understood that other kind of technology of coating reflective material on the inner wall of the hole is also applicable.

The proposed optical coupling structure can be used with the above optical tapped linear driver. It can also be used independent from the optical tapped linear driver, and used in a context where isolation between high voltage and low voltage circuitry is required and optical coupling should be as high as possible, while not making the PCB area too large. With this new implementation extra encapsulation material is not needed anymore.

In the claims, any reference signs placed in parentheses shall not be construed as limiting the scope. The word ‘comprising’ does not exclude the presence of elements or steps other than those listed in the claim. The word ‘a’ or ‘an’ preceding an element does not exclude the presence of a plurality of such elements. The mere fact that certain measures are recited in mutually different dependent claims does not indicate that the combination of these measures cannot be used to advantage.

1. Circuit including
at least a first and a second LED lighting element,
a control circuit for controlling operation of said first LED lighting element in dependence on a light feedback signal (L) delivered by a light sensitive element,
said light feedback signal (L) being dependent on light emitted from said second LED lighting element except for said first LED lighting element;
wherein said first and said second LED lighting element are in series connection and adapted to be connected between a variable supply voltage (V), and said control circuit is in parallel connection with said first LED lighting element; or
said first and said second LED lighting element are in parallel connection and adapted to be connected between a variable supply voltage (V), and said control circuit is in series connection with said first LED lighting element.

2. Circuit according to claim 1, wherein said first and said second LED lighting element are in series connection, and said control circuit is in parallel connection with said first LED lighting element, and
said control circuit is adapted to:
deactivate said first LED lighting element by bypassing the first LED lighting element and allow operation of the second LED lighting element in response to reduced light emitted from said second LED lighting element; and
disable the bypass and allow the first LED lighting element to be operated by said supply voltage (V), in response to the light with increased luminous flux is emitted from said second LED lighting element.

3. (canceled)

3. Circuit according to claim 1, wherein said first and said second LED lighting element are in parallel connection, and said control circuit is in series connection with said first LED lighting element, the second LED lighting element has higher forward voltage than the first LED lighting element, and
said control circuit is adapted to:
be conductive and activate the first LED lighting element; and
be un-conductive and deactivate the first LED lighting element in response to the increasing light feedback signal (L) as the luminous flux of the second LED lighting element increases.

4. Circuit according to claim 1, wherein said control circuit comprises said light sensitive element.

5. Circuit according to claim 1, wherein said first and second LED lighting elements are adapted to be connected to an external common power supply (S).

6. Circuit according to claim 5, wherein said first and second LED lighting element are adapted to be connected with the external power supply (S) which supplies electrical power with varying voltage (V).

7. Circuit according to claim 1, further including at least
a further LED lighting element,
and a further control circuit for controlling operation of said further LED lighting element in dependence on a further light feedback signal delivered by a further light sensitive element,
said further light feedback signal being dependent on at least a portion of light emitted from said first LED lighting element.

8. Circuit according to claim 1, wherein said control circuit is disposed to increase power delivered to said first LED lighting element with an increasing light feedback signal (L).

9. Circuit according to claim 1, wherein
said control circuit comprises at least a bypass current path allowing a bypass current (I_{B}) to flow,
and an optical feedback circuit (Q₃) to at least reduce said bypass current (I_{B}) with increasing light feedback signal (L).

10. Circuit according to claim 1, wherein said control circuit is disposed to decrease power delivered to said first LED lighting element with an increasing light feedback signal (L).

11. Circuit according to claim 1, wherein a current limiting means (R_{L}) is connected to limit a current supplied by an electrical power supply (S) to at least one of said first and/or second LED lighting element.

12. Circuit according to claim 1, wherein one of said first and a second LED lighting elements and said a light sensitive element are arranged on a common substrate.

13. Circuit according to the claim 12, wherein said light sensitive element and said second LED lighting element further comprises:
the substrate on which said second LED lighting device and said light sensitive element (52) are mounted;
wherein said substrate comprises a hole and said second LED lighting element is adapted to emit light into the hole and said light sensitive element for light detection is adapted to receive light from the hole.

14. Method of operating LED lighting elements, comprising
providing at least a first and a second LED lighting element, and a control circuit, wherein said first and said second LED lighting element are in series connection and adapted to be connected between a variable supply voltage (V) and said control circuit is in parallel connection with said first LED lighting element; or said first and said second LED lighting element are in parallel connection and adapted to be connected between a variable supply voltage (V) and said control circuit is in series connection with said first LED lighting element,
obtaining a light feedback signal (L) dependent on light emitted from said second LED lighting element except for said first LED lighting element,
and controlling operation of said first LED lighting element in dependence on said light feedback signal (L).

15. Circuit according to claim 1, wherein said control circuit is adapted to:
deactivate said first LED lighting element in response to reduced light when said supply voltage (V) is less than the sum of the forward voltages of the second LED lighting element and the first LED lighting; and
disable the bypass in response to the light with increased luminous flux when said supply voltage (V) increases.

16. Circuit according to claim 1, wherein said control circuit is adapted to:
be conductive and activate the first LED lighting element when the supply voltage (V) is below the forward voltage of the second LED lighting element;
be un-conductive and deactivate the first LED lighting element as the supply voltage (V) increases above the forward voltage of the second LED lighting element.
